(19) United States
(12) Patent Application Publication
(10) Pub. No.: US 2016/0012501 A1
(43) Pub. Date: Jan. 14, 2016

(54) SYSTEM AND METHOD FOR AUTOMATED NETWORK PURCHASE QUEUE

(71) Applicant: Cartque Inc., Dallas, TX (US)

(72) Inventor: Asker A. Ahmed, Irving, TX (US)

(73) Assignee: Cartque Inc., Dallas, TX (US)

(21) Appl. No.: 14/794,721

(22) Filed: Jul. 8, 2015

Related U.S. Application Data
(60) Provisional application No. 62/021,944, filed on Jul. 8, 2014.

(51) Int. Cl. G06Q 30/06; G06Q 50/00; H04L 29/08; G06F 17/30

(52) U.S. Cl. CPC G06Q 30/0605; G06Q 30/0609; G06F 17/30867; G06Q 50/01; H04L 67/306

(57) ABSTRACT

An automated queuing system for purchasing merchandise online. The system aggregates interested users for a particular product and negotiates a bulk discounted price. The system can automatically inform a user of directed offerings based on user inputs and can automatically enter the user in a queue for particular products. The user selects a queue for a desired product and if the queue generates a target number of users over a specified duration, the vendor will provide a voucher for a discounted purchase price to each user in the queue. The system comprises a browser plug-in loaded on a user device connected to the Internet and a vendor network. In an alternate embodiment, the system comprises an application running on a mobile device.

### CROSS-REFERENCE TO RELATED APPLICATION

This application claims priority to U.S. Provisional Application No. 62/021,944 filed Jul. 8, 2014. The patent application identified above is incorporated here by reference in its entirety to provide continuity of disclosure.

### FIELD OF THE INVENTION

The present invention relates to systems and methods for generating and distributing product related content and electronic network devices that aggregate purchase results to drive price a reduction from vendors. In particular, the present invention relates to systems and methods of gathering the collective bargaining power of a group of similarly situated internet users related to sets of questions, answers, tips and comments related to internet content.

### BACKGROUND

U.S. Pat. No. 7,146,330 to Alon, et al. discloses a method and system for creating and managing groups for increasing online buying power. The system is comprised of a computer to facilitate a sales transaction between a group of buyers and at least one seller. Potential buyers create a group organized for making a request for the purchase of a product/service. The computer system provides the group's request for the product/service to one or more sellers of the requested product/service. Sellers respond by providing a price quote for the requested item, often on the basis of the number of such items to be purchased by the group and the computer system notifies the group members of the price quote. Individual buyers from the group may commit themselves to purchasing the item at the specified price or continue to negotiate a price. Additionally, sellers may review the price quotations submitted by other sellers and submit competing price quotations. However, Alon, et al. does not sufficiently facilitate creation of the groups, nor does it adequately facilitate choosing a target product.

U.S. Pat. No. 6,260,024 to Shkedy discloses a system comprised of a computer acting as a central controller or intermediary to facilitate a transaction between a plurality of buyers and at least one seller. A buyer provides a conditional purchase order (e.g., size, quantity, timeline) for a particular product or service to the central controller. The intermediary provides a maximum offer price to the buyer which meets the conditions. The buyer either accepts or rejects the offer price from the intermediary. If the buyer accepts the offer price, the buyers' conditional purchase order is combined into a pooled purchase order with other buyers. The pooled purchase order is then made available to sellers to bid on. Any sellers interested in the pooled purchase order will submit a bid including a bid price that is responsive to the conditional pooled purchase order, including the maximum offer price. The intermediary selects a seller whose bid is the best, such as lowest price and payment is provided by the intermediary to the seller upon delivery of the product or service. The intermediary may charge a transaction fee to the buyers for the service. However, Shkedy does not sufficiently facilitate creation of the groups, nor does it adequately facilitate choosing a target product.

WIPO International Patent Application Publication No. WO 2013/101192 to Prakash, et al. discloses a method and system for bulk purchase negotiating using an ad hoc online group. The system is comprised of a central networked computing device capable of receiving a request from users of the system (buyers) for the formation of an online group interested in the purchase of a particular product or service. The central computing device provides an online forum for a group of buyers interested in the product to negotiate with vendors of the product for a bulk purchase price. Additionally, the central computing device facilitates communications between individual members of the group. Once a negotiated price is reached, the central computing device facilitates the financial transaction and delivery of the product or service. Buyers may transmit funds for the purchase through the central computing device or directly to the vendor. The online group is removed from the system once all transactions are final. However. Prakash, et al. does not adequately facilitate product selection, nor does it provide geolocation of a target product queue.

### SUMMARY

In a preferred embodiment, the system provides a browser plug-in and Android and iOS applications by which shoppers at a website add themselves to a “queue,” instead of adding an item to cart. Once a queue is initiated, and a predetermined number of users join the queue, the system negotiates a discount on their behalf.

The preferred mobile application for iOS and Android utilizes GPS and other technologies in the mobile devices to create virtual fences and combines them with an active queuing system for group purchasing which allows consumers to identify and syndicate offers on goods & services online and in brick-and-mortar stores.

In operation, if a vendor agrees to give a discount for a volume purchase, the system shares a discount code with all users in the queue. The system charges a transaction fee from the users prior to releasing the discount code.

Users can add themselves to a queue on any supported website. Once a given number of users are in the queue (e.g., 20 users in queue), or the time for the queue has expired (e.g., one week), the queue automatically closes and the users receive a discount that the system has negotiated with the vendor. New users can start a queue if there is no active queue for a particular product. Each product has its own unique queue. Users may add themselves to multiple queues on the same website or across multiple websites.

In one embodiment, the system consists of a browser plug-in that a user can download for their web browser on their PC, Mac, as well as a mobile application for Android and iOS devices. The browser plug-in is compatible with most major browsers. In an alternate embodiment, a code snippet can be placed on a supported vendor website to create a queue icon.

Whenever the user is shopping and is about to add an item to cart, instead of clicking on the add-to-cart button, they click on an add-to-queue symbol. This adds the item to the queue.

The system database consists of the websites with active queues and information such as users, email addresses associated with users, vendor negotiation emails, etc.

The system is automated. Whenever a user joins the system, their information such as username and email address, is logged into the database. This information is automatically accessed when the user initiates a queue. Alternatively, a vendor may directly set up a queue in the system. Once a certain number of users are added to an established queue, the system administrator negotiates with the vendor as to a discount offer. If the vendor accepts the offer, the system administrator makes the discount code available to the queue users for that product and takes a transaction fee. The users then receive a discount code.

If the user lands on a website not vetted by the system, they can still add themselves to a queue. The system administrator is notified of a new vendor request. They then update the vendor contacts database with the new vendor info.

In another embodiment, the end user installs an application on his or her mobile device.

The mobile device application requests the ability to track the location of the user via GPS and other technologies. This allows the system to know when the user is within close proximity of one of the participating brick-and-mortar stores. When a user is within close proximity to one of the brick-and-mortar stores, the system notifies the user that they have entered a store recognized in the system.

The system administrator negotiates an offer with the vendor while the queue is active. In one embodiment, the vendor system may automatically accept the offer without advance notification of the system administrator.

Vendors can create marketing campaigns for the system. For example, a vendor can view a live feed of active queues across all stores. For those active queues that don't have a coupon defined, vendors can enter a discount into the system while a queue is active or while the system administrator is negotiating a discount.

The system provides a screen where a user can select a category of products. For example, if a user enters a brick-and-mortar store, the brick-and-mortar store may provide categories like computers and tablets, mobile phones, televisions and appliances. By just choosing one category, the user is automatically added to the queue for each product.

The queues are dynamic, and the system constantly updates the total number of users in each queue across all stores. The system can display a total for each store, each category, and each product in that category.

If the number of users in the queue exceeds a critical mass number, then a coupon code can be automatically generated and made available for all users in the queue. The coupon code has a short life (for example, 24 hours) and disappears or becomes invalid if not used within this life.

Once a coupon is generated, the user is removed from the queue and the queue is closed. Once a queue is closed, it expires, does not remain or restart again. For example, if there were 200 people in the queue and the critical mass number was 200, when 200 is reached, discount code is available instantly to all people in the queue. In one embodiment, the queue continues to be active for 6 hours from a countdown period shown on the application screen. So even after the critical mass number is reached, the queue continues to be active.

The system has preferences tabs where the user can set preferences on alerts, notifications, stores, etc.

The system provides the user timely instructions on how best to use the application during initial setup.

### BRIEF DESCRIPTION OF THE DRAWINGS

FIG. 1 is a system architecture drawing of a preferred embodiment.

FIG. 2 is a network sequence drawing of a preferred embodiment.

FIG. 3 is a network sequence drawing of an alternate preferred embodiment.

FIGS. 4A and 4B are screen captures of a browser loaded with a browser plug-in of a preferred embodiment.

FIG. 5 is a graphic display provided to a user workstation from a plug-in of the preferred embodiment.

FIGS. 6A, 6B and 6C are network sequence diagrams of a preferred embodiment.

FIGS. 7A and 7B are a network sequence diagram of an alternate preferred embodiment.

FIG. 8 is a preferred embodiment of a display screen on a mobile device.

FIG. 9 is an alternate embodiment of a display screen on a mobile device.

FIG. 10 is an alternate embodiment of a display screen on a mobile device.

FIG. 11A are examples of the source code for generating a queue schedule, transmitting a GPS range, and transmitting the location of a user device.

FIG. 11B are examples of the source code for analyzing the position of a user device and entering a queue on a user device.

FIG. 11C are examples of the source code for aggregating a queue status, staring a queue timer, and generating a queue start message.

FIG. 11D are examples of the source code for adding a user to a queue and sending a discount code to a user device.

### DETAILED DESCRIPTION

It will be appreciated by those skilled in the art that aspects of the present disclosure may be illustrated and described in any of a number of patentable classes or contexts including any new and useful process or machine or any new and useful improvement. Aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Each hardware device is understood to include a computer processor, modem, communication capability, display capability and functional input and output devices. Typical of this hardware is a computer server such as Microsoft Windows Server 2008 R2 Standard and a smartphone device such as a Samsung Galaxy S4 running an Android operating system or an Apple iPhone running iOS. Further, aspects of the present disclosure may take the form of a computer program product embodied in one or more computer readable media having computer readable program code embodied thereon.

It will be appreciated by those skilled in the art that the described embodiments disclose significantly more than an abstract idea and include technical advancements in the field of data processing and a transformation of data which is directly related to real world objects and situations and enable a computer system to operate more efficiently and solve a problem particular to the Internet with a technical solution particular to the Internet.

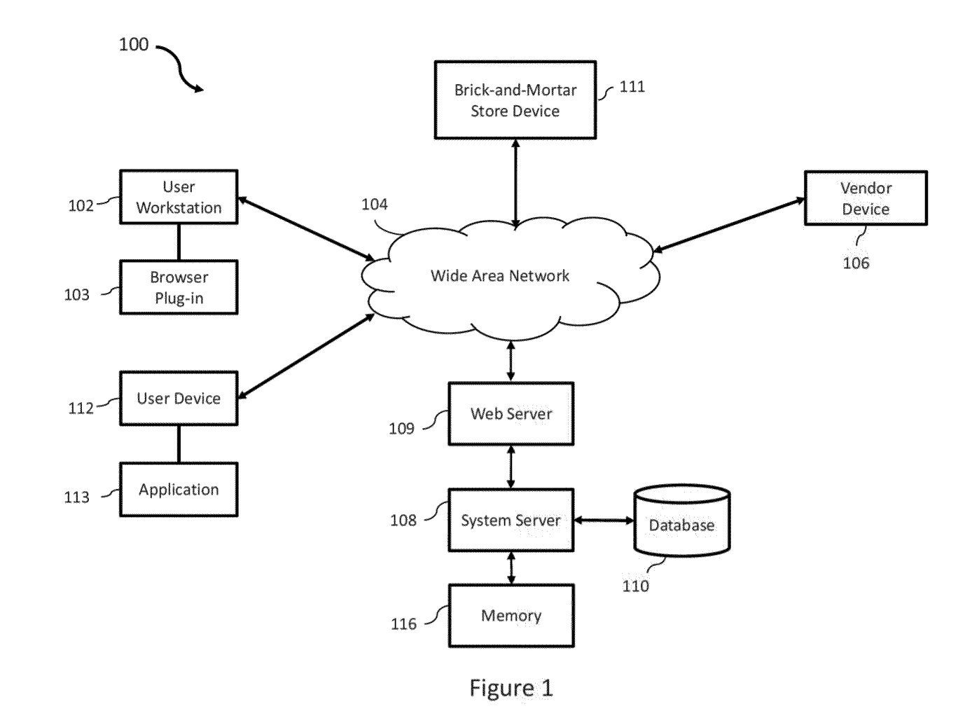

Referring then to FIG. 1, system 100 includes user workstation 102 connected to a wide area network 104, such as the Internet. In a preferred embodiment, user workstation 102 is a personal computer including a browser, such as Google Chrome® or Apple Safari®. In other preferred embodiments, user workstation 102 may take the form of a smart phone, a tablet or a portable computer.

User workstation 102 includes browser plug-in 103. As is known in the art, a browser plug-in is a software component that adds a specific feature to an existing software application. When an application supports browser plug-ins, it enables the customization. Common browser plug-ins known in the art include search engines, virus scanners, and various file type decoders such as video viewers and .mp3 players. User device 112 is a tablet, computer or smart phone. User device 112 includes application 113.

The system further comprises vendor device 106 and a brick-and-mortar store device 111 connected to wide area network 104. The system includes a system server 108 connected to database 110 and memory 116. System server 108 is connected to the wide area network, via web server 109, and maintains communication between user workstation 102, user device 112, vendor device 106 and brick-and-mortar store device 111.

In a preferred embodiment, system server 108 has the following specifications:

| | |
|---|---|
| OS Name | Ubuntu Server |
| Version | 14.04.2 LTS |
| OS Manufacturer | Canonical Ltd. |
| System Manufacturer | ASUSTek |
| System Model | P8H77 |
| System Type | x64-based Linux |
| Processor | Intel(R) Core(TM) CPU i7-3770 @ 3.40 GHz, |
| | 2400 Mhz, 4 Core(s), 8 Logical Processor(s) |
| BIOS Version/Date | American Megatrends Inc. v9002, 05/30/2014 |
| Installed Physical | 32.0 GB |
| Memory (RAM) | |
| Total Physical Memory | 32.0 GB |
| Description | Disk drive |
| Manufacturer | Seagate |
| Model | Adaptec Array SCSI Disk Device |
| Media Loaded | Yes |
| Media Type | Fixed hard disk |
| Partitions | 4 |
| Size | 2794.00 GB (3,000,034,656,256 bytes) |
| Speed | 7,200 rpm |
| Partition | Disk #0, Partition #0 |
| Partition Size | 15.00 GB (16,106,127,360 bytes) |
| Partition | Disk #0, Partition #1 |
| Partition Size | 511.00 MB (548,682,072 bytes) |
| Partition | Disk #0, Partition #2 |
| Partition Size | 1023.00 GB (1,098,437,885,952 bytes) |
| Partition | Disk #0, Partition #3 |
| Partition Size | 1754.00 GB (1,883,343,159,296 bytes) |

Other suitable servers and server specifications may be employed.

In a preferred embodiment, user workstation 102 is a personal computer running an operating system such as Microsoft Windows having the following specifications:

| | |
|---|---|
| OS Name | Microsoft Windows 7 Ultimate |
| Version | 6.1.7601.17514 |
| OS Manufacturer | Microsoft Corporation |
| System Manufacturer | ASUSTek |
| System Type | x64-based PC |
| Processor | Intel(R) Core(TM) CPU i7-4770k @ 4.00 GHz, |
| | 4 Core(s), 8 Logical Processor(s) |
| Installed Physical | 32.0 GB |
| Memory (RAM) | |
| Total Physical | 32.0 GB |
| Memory | |
| Description | Solid state drive |
| Manufacturer | Samsung |
| Description | 850 Pro Series MZ-7KE1T0BW |
| Partitions | 1 |
| Size | 1023.00 GB (1,098,437,885,952 bytes) |
| Speed | 550 MB/s sequential |
| Partition | Disk #0, Partition #0 |
| Partition Size | 1023.00 GB (1,098,437,885,952 bytes) |

Other suitable workstations and workstation specifications may be employed. Other operating systems may be employed.

In a preferred embodiment, user device 112 is a Galaxy S4 smartphone by Samsung Electronics having the following specifications:

| | |
|---|---|
| Description | Samsung Galaxy S4 |
| Manufacturer | Samsung |
| Model | SPH-L720 |
| Carrier | Sprint |
| Hardware Version | L720.08 |
| Android Version | 4.4.2 |
| Baseband Version | L720VPUFNG2 |
| Kernel Version | 3.4.0-2162929 |
| Build Number | KOT48H.L720VPUFNG2 |
| Memory | 16 GB |

In another preferred embodiment, user device 112 is an iPhone 6 smartphone by Apple having the following specifications:

| | |
|---|---|
| Description | Apple iPhone 6 |
| Manufacturer | Apple |
| Model | MG562LL/A |
| Carrier | T-Mobile |
| Networks | Quad Band GSM; LTE; UMTS |
| Operation System | iOS 8, upgradable to 8.4 |
| Processor | A8 Dual-core 1.4 GHz Cyclone (ARM v8-based) |
| Build Number | 12A365/12H143 |
| Memory | 16 GB |

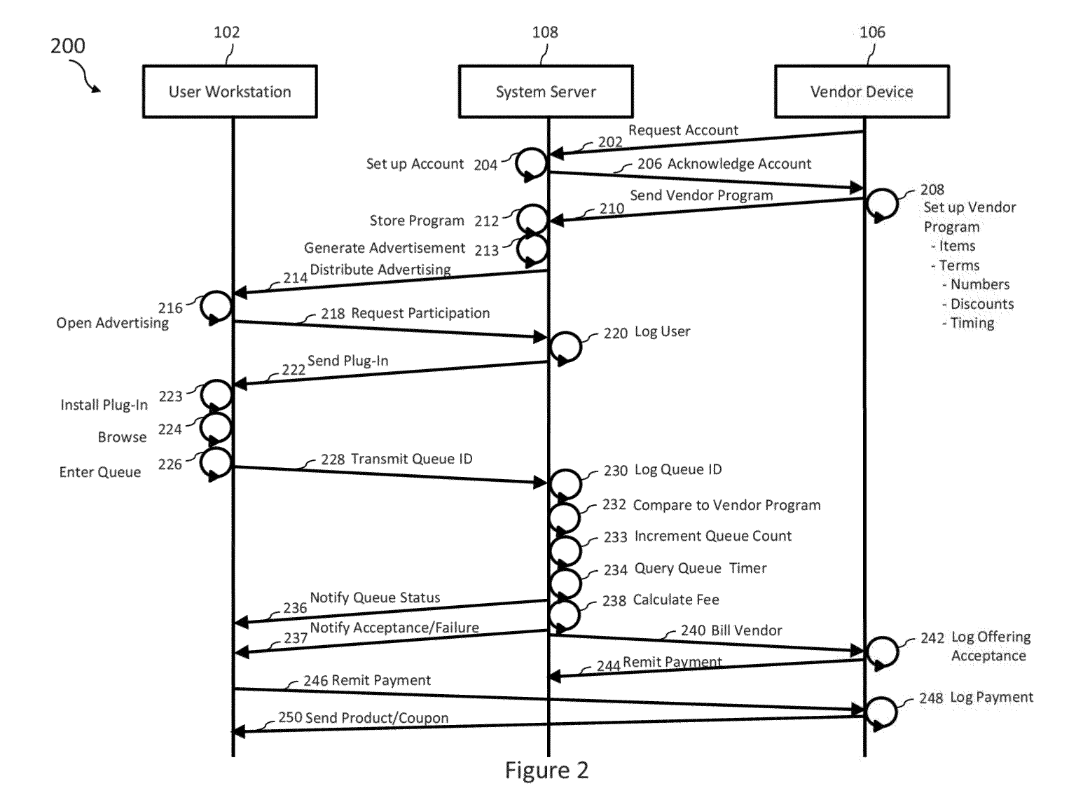

Referring then to FIG. 2, the preferred embodiment of method 200 is described. FIG. 2 shows three tiers of devices user workstation 102, system server 108 and vendor device 106. Each is connected to the network. User device 112 may be substituted for user workstation 102. At step 202, vendor device 106 requests an account. At step 204, the system server sets up an account. In a preferred embodiment, the account includes an identification of the vendor and limits for payment terms.

An administration interface is available on the system server and provides functionality to the system administrator during account set-up and offer negotiations. In a preferred embodiment, the administration interface provides the following:

Define Retailers—Upload list of all the retailers with addresses across the country (for GPS etc. mapping).

Generate National Login—This allows stores to control a campaign at national level across all stores.

Define Categories—Define category specific to each vendor. For example, Best Buy® may have all its products under categories such as Computers and Tablets, Mobile Phones and Accessories, TV and Video, Appliances, Music, etc. Similarly, Macy's® may have a different set of categories, Men's Apparel, Women's Apparel, Home Furnishings, Kitchen Appliances, Fragrances and Makeup etc.

At step 206, the system server acknowledges the account. In a preferred embodiment, acknowledging the account includes providing the vendor a listing of terms and conditions for use of the system.

At step 208, the vendor sets up a vendor program. In a preferred embodiment, the vendor program includes an identification of the items to be offered, and the terms under which the items are offered and the geographic limits of any product or product queue.

In a preferred embodiment, the terms include the number of products which will constitute a “critical mass.” The critical mass is a number of items which must be purchased in order to achieve the discount offered or to open negotiations. The terms also include a discount to be offered, and a time period during which the offer will be open. For example, the vendor can elect that a campaign will run Saturday, Dec. 13, 2014 from 12 pm to 8 pm. This would mean this campaign is activated and runs for the designated 8 hour period. In this period, whenever the critical mass count is reached, group discount code is provided to each user or negotiations begin. The “countdown timer” begins once the critical mass number is reached. During the countdown timer window, a user may add himself to the queue even after the critical mass number has been reached. But the queue stops once the countdown timer expires. In an alternate embodiment, an additional timer may extend the queue availability time after expiration of the initial timer.

In a vendor program, a vendor selects one or more categories from their ‘pre-defined’ list of categories that was uploaded by the system administrator. The vendor can then define the campaign for these categories. The vendor can also upload selected advertisements for the product queue. For example, if the vendor is Best Buy®, which has categories like Computers and Tablets, Music, Appliances, TVs and Video, etc., a campaign may be started for only Computers and Tablets. In this case, they would select Computers and Tablets, and then define their offer by identifying the % discount, the critical mass number. Once the critical mass number of users is in the queue, every user receives the discount code.

In a preferred embodiment, the discount code includes a hash code of several pieces of information. The hash code includes a hash of product type identifier, the product location, the user identification, the server identification, the queue tracking number and the time and date. In a preferred embodiment, a hash function is used in the hash code which is a cryptographic hash code or a hash table. Only the hash value is transmitted to the user and must be present to reconstruct the input data.

At step 210, the vendor program is sent to the system server. At step 212, the system server stores the program in the database. At step 213, an advertisement is generated by the system server based on product data or accessed from the database. At step 214, the advertisement related to the vendor program is distributed to user workstation 102. At step 216, the user workstation opens the advertisement and views the vendor program. At step 218, the user workstation requests participation in the system by transmitting a message to the system server. At stop 220, the system server logs the user workstation's request for participation and adds it to the database. At step 222, the system server sends a browser plug-in or queue icon to the user workstation device. At step 223, the user workstation installs the browser plug-in or queue icon.

At step 224, the user workstation browses the vendor's website. At step 226, the browser enters a queue via the plug-in. At step 228, the plug-in transmits a queue identification number to the system server. At step 230, the system server logs the queue identification number. At step 232, the system server compares the queue identification number to the vendor program stored in the database. At step 233, the system server increments the queue count by the number of products requested for purchase requested by the user. At step 234, the system server queries the queue timer. In a preferred embodiment, if the queue timer has expired, the request to enter the queue is rejected. In another preferred embodiment, if the queue timer has expired a message is sent to the user workstation requesting that it enter another queue. In this embodiment, the queue size automatically resets to zero (0) when it reaches the critical mass number. In another preferred embodiment, if the queue timer has not yet been activated, the queue timer is activated. At step 236, the user workstation is notified as to the queue status. At step 237, if the queue count has reached a predetermined number, the “critical mass” number before the queue timer expires, then user workstation is notified of the acceptance of the offering. If the queue count has not reached the critical mass number or if the queue timer has expired, then the user workstation is notified of an offering failure and asked to join another queue.

At step 238, system server 108 calculates a service fee. At step 240, the server transmits the offer acceptance and the vendor is billed the service fee. At step 242, the vendor logs acceptance of the offering. At step 244, the vendor remits payment to the system server. At step 246, if the offering is accepted, then the user workstation remits payment to the vendor. At step 248, the vendor logs the payment. At step 250, the product is shipped. In an alternate embodiment, at step 250, a coupon is provided for a discount on the product or service. The coupon includes the hash code as previously described.

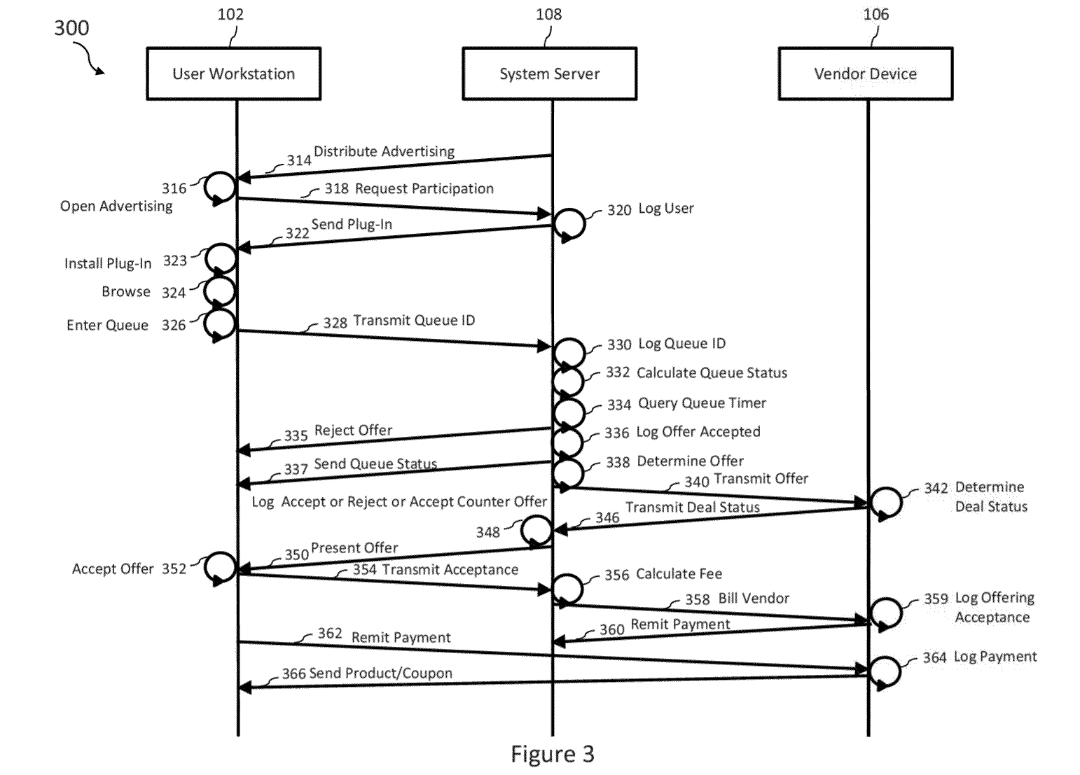

Referring then to FIG. 3, an alternate embodiment of system 300 will be described.

At step 314, an advertisement related to the vendor program is distributed to user workstation 102. At step 316, the user workstation opens the advertisement and views the vendor program. At step 318, the user workstation requests participation by transmitting a message to the system server. At step 320, the system server logs the user workstation's request for participation and adds it to the database. At step 322, the system server sends a browser plug-in to the user workstation. At step 323, the user workstation installs the browser plug-in.

At step 324, the user workstation browses the vendor's website. At step 326, the user workstation enters a queue via the plug-in. At step 328, the user workstation transmits a queue identification number to the system server via the plug-in. In a preferred embodiment, the queue identification number is a hash code of the product identification, a user identification number and the date and time. At step 330, the system server logs the queue identification number.

At step 332, a queue status is calculated. In a preferred embodiment, the queue status is calculated by aggregating the number of entries in the queue and then comparing the aggregate number of entries to a predetermined critical mass number for the vendor program. The queue status is “unopened,” if there are zero (0) entries in the queue at the time that the queue status is calculated. The queue status is “pending,” if the aggregate number of entries received into the queue is greater than zero but less than the predetermined critical mass number. The queue status is “full,” if the aggregate number of entries received into the queue is greater than or equal to the predetermined critical mass number. At step 334, the queue timer is queried. At step 335, if the timer is expired, then the offer is rejected. In another embodiment, if the offer is expired, the user workstation is requested to join another queue at this step. At step 336, if the timer is not expired then an “offer acceptance” is logged in the database. At step 337, the queue status is sent to the user device.

At step 338, the database is queried to determine the terms of the offer.

At step 340, the offer is transmitted to the vendor in order to open negotiations. In a preferred embodiment, negotiations are conducted, in person, between the administrator as a proxy for the users, and the vendor. In another preferred embodiment, the negotiations are carried out automatically between the system server and the vendor device. The automatic negotiations take place through a series of offers and responsive counter-offers that are provided according to the predetermined schedules, price levels and product inventory levels resident on the system server and the vendor device. At step 342, the deal is “accepted,” “rejected” or a “counter offer” is determined by the vendor. At step 346, the acceptance, rejection or counter offer is transmitted to the system server. At step 348, the rejection or acceptance is logged or the counter offer is accepted. If the counter offer is accepted, then at step 350, the counter offer is presented to the user workstation. At step 352, the user workstation accepts the offer. In a preferred embodiment the acceptance is made manually by the user by observing and responding to the offer or counter offer. In another embodiment, the acceptance takes place automatically by triggering a predetermined acceptance level at the user workstation, set by the user as a preference.

At step 354, the offer acceptance is transmitted to the system server. At step 356, the system server transmits the offer acceptance and calculates a service fee. At step 358, the service fee is billed to the vendor. At step 359, the vendor logs acceptance of offer. At step 360, payment is made to the system server. At step 362, the user workstation remits payment to the vendor. At step 364, the vendor logs the payment. At step 366, the product is sent to the user workstation. In an alternate embodiment, a coupon redeemable for goods or services or a discount on goods or services is sent to the user workstation. The coupon includes a hash code as previously described.

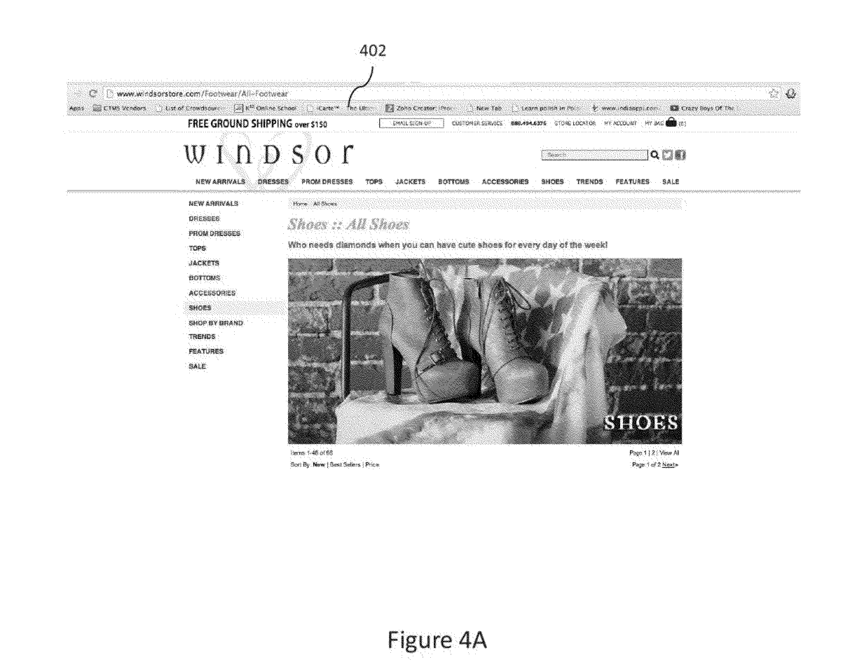

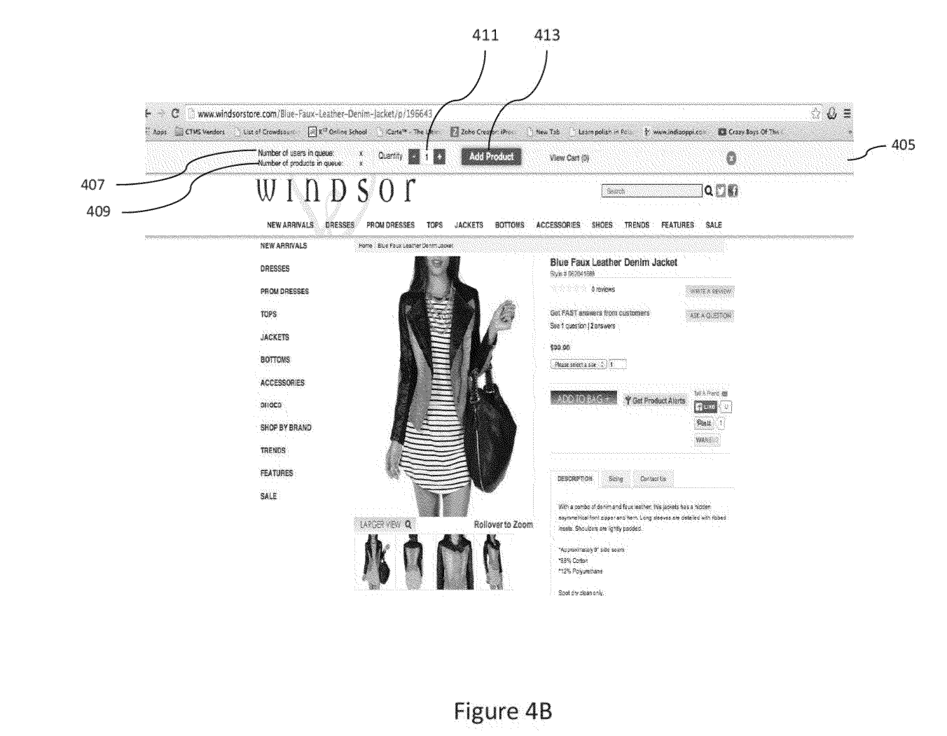

Referring then to FIGS. 4A and 4B, a graphic of a preferred embodiment of the system display is shown. In FIG. 4A, a browser plug-in button is shown as “queue” button 402. By clicking queue button 402, the browser plug-in is invoked for the system. Referring to FIG. 4B, plug-in bar 405 is displayed by the plug-in browser. The display includes number of users in queue 407 and number of products in queue 409, quantity button 411 and “add product” button 413. Number of users in queue 407 shows the number of users in any particular queue for any particular product. Number of products in queue 409 similarly shows the number of products for which the user workstation has entered a queue. Quantity button 411 allows the user workstation to increase or decrease the quantity of items shown in the queue. Add product button 413 enters the user workstation into the queue for that particular product. In an alternate embodiment, an indicator is presented in the display also includes a timer display (not shown), indicating the time left on the queue. If the queue is untimed, no timer display is shown.

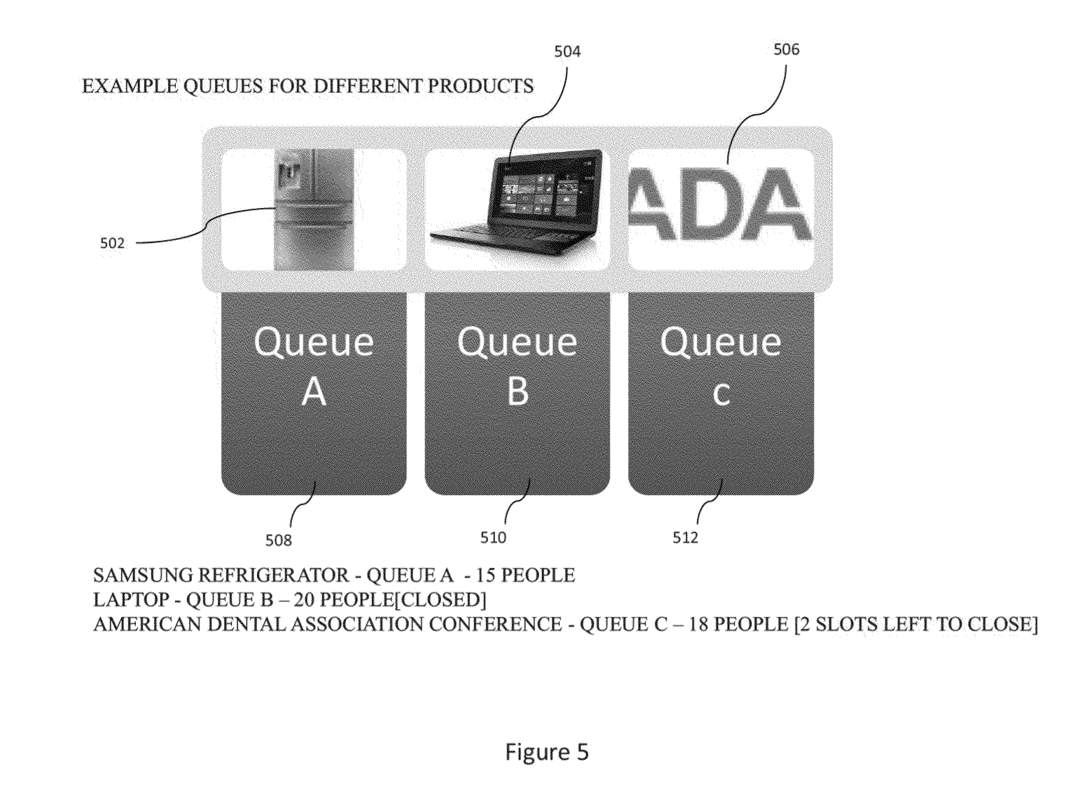

Referring then to FIG. 5, a graphic display provided to the user workstation from the plug-in is described. In this example, a graphic window, such as windows 502, 504 and 506, are presented to the user. A queue status button is also provided in this example. Each queue represents a particular product shown at 508, 510 and 512. When the user workstation clicks the queue status button, the user workstation is presented with the terms of the offer and the status of the queue and the queue timer.

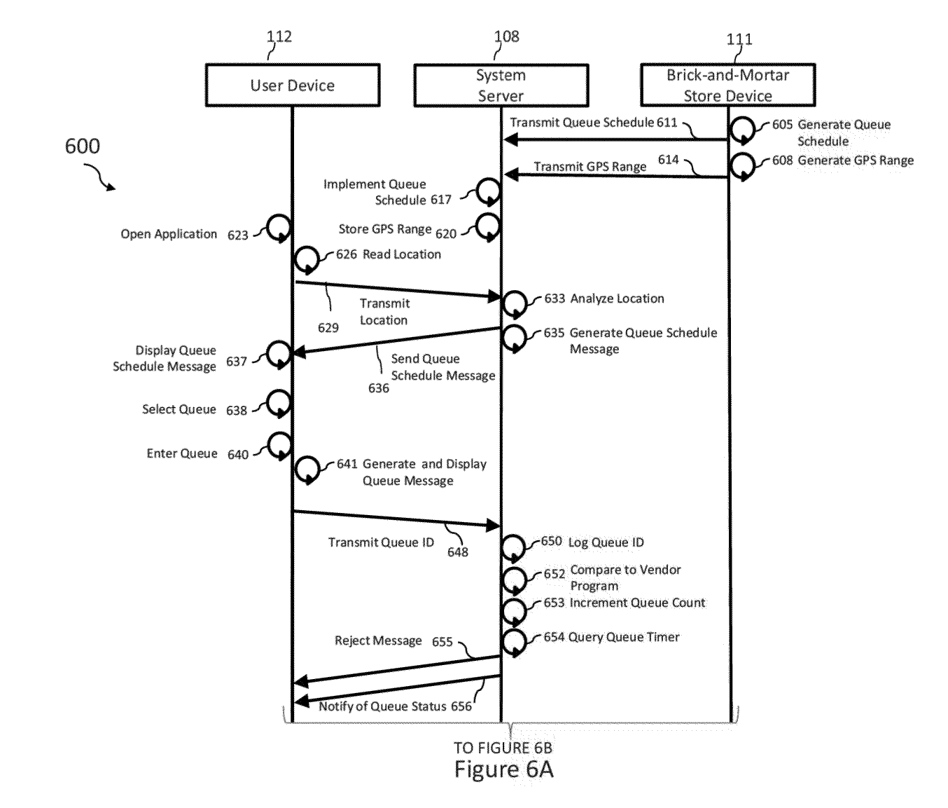

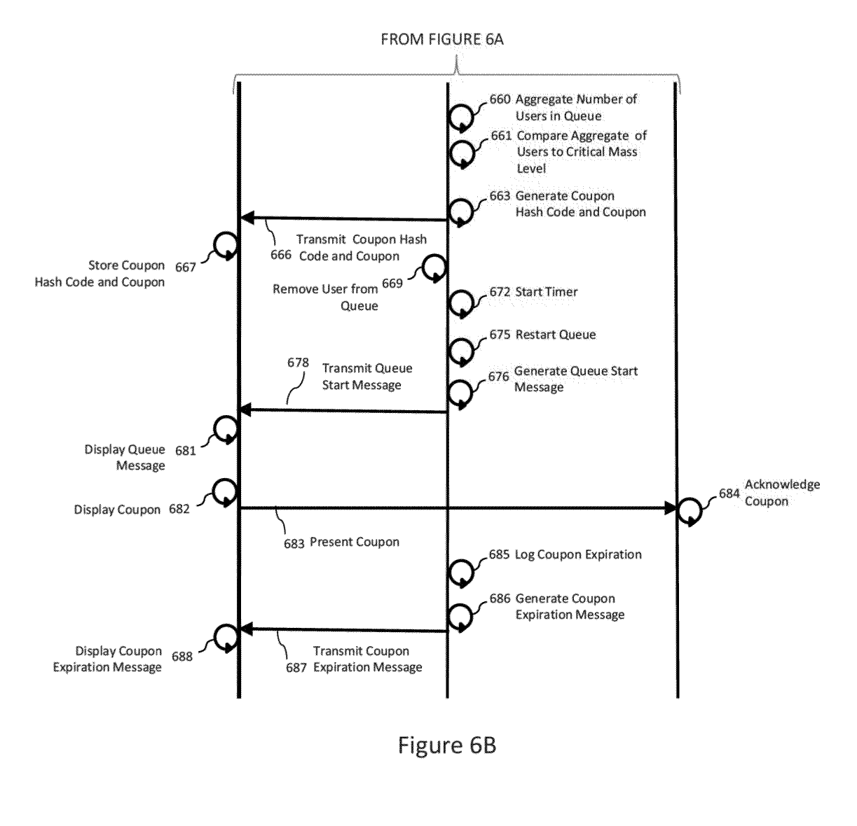

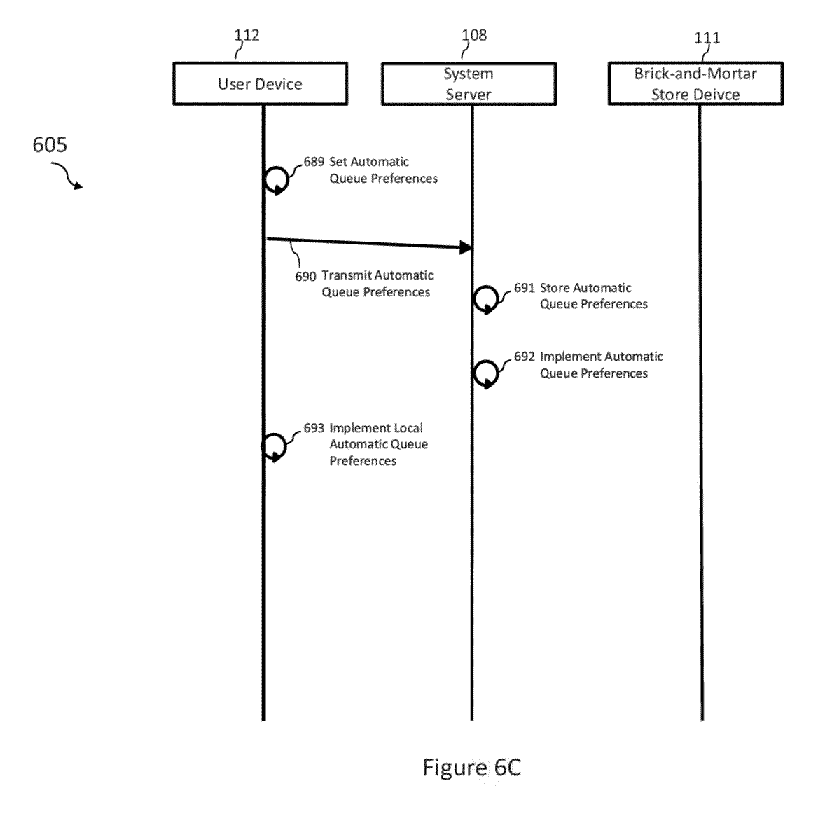

Referring then to FIGS. 6A and 6B, an alternate method, method 600 will be described. At step 605, brick-and-mortar store device 111 generates a queue schedule. A queue schedule includes a calendar of when product offerings will occur. A queue schedule also includes what products or services will be offered during the schedule. At step 608, brick-and-mortar store device 111 generates a GPS range in which the queue schedule will be valid. At step 611, brick-and-mortar store device 111 transmits the queue schedule to the system server. At step 614, brick-and-mortar store device 111 transmits the GPS range to the system server. In a preferred embodiment, a GPS range is of circular perimeter of predetermined radius centered at the location of the brick-and-mortar store. At step 617, the queue schedule is stored and implemented. At step 620, the system server stores the GPS range and associates it in a database with the brick-and-mortar store identification.

At step 623, user device 112 opens application 113. At step 626, user device 112 reads its location from an onboard geolocation system, such as a GPS tracking system. At step 629, user device 112 transmits its location, and GPS coordinates to the system server. At step 633, the system server analyzes whether or not the transmitted location of the user is inside or outside the valid GPS range. If the transmitted location is within the GPS range, then system server proceeds at step 635. At step 635, system server generates a queue schedule message. At step 636, the queue schedule message is sent to the user device. At step 637, user device 112 displays the queue schedule message. At step 638, user device 112 selects a desired queue. At step 640, the user device enters the queue via the application. At step 641, the user device generates and displays a queue message.

At step 648, the application on user device 112 transmits a queue identification number to the system server. At step 650, the system server logs the queue identification number. At step 652, the system server compares the queue identification number to the vendor program stored in the database. At step 653, the system server increments the queue count by the number of products requested for purchase requested by the user. At step 654, the system server queries the queue timer. At step 655, if the queue timer has expired, then the request to enter the queue is rejected and a message is sent to the user device. In another preferred embodiment, if the queue timer has expired a message is sent to the user device requesting that it enter another queue. In this embodiment, the queue size automatically resets to zero (0) when it reaches the critical mass number. In another preferred embodiment, if the queue timer has not yet been activated, and a queue timers exists for the product queue, then the queue timer is activated.

At step 656, the user device is notified as to the queue status. If the queue count has reached a predetermined number, the “critical mass” number, and if the queue timer has not expired, then user device 112 is notified of the acceptance of the offering. If the queue count has not reached the critical mass number, then the user device is notified of the termination of the offering and may be asked to join another queue.

Moving then to FIG. 6B, at step 660, the system server aggregates the number of users in the product queue from all brick-and-mortar stores devices. At step 661, the system server compares the aggregate queue number to the critical mass level. If the aggregate queue number meets or exceeds critical mass level, then the system server moves to step 663. At step 663, the system server generates a coupon hash code and a graphics of the coupon, containing the hash code. At step 666, the coupon hash code and a graphics file of a coupon are transmitted to user device 112. At step 667, the user device stores the coupon hash code and a graphics of the coupon. At step 669, the system server removes the user device identification number from the queue. At step 672, the system server starts a timer related to the coupon. At step 675, the queue is restarted by the system server. In an alternate embodiment, the queue is not restarted. At step 676, if the queue is restarted, then the system server generates a queue start message. At step 678, the queue start message is transmitted to user device 112. At step 681, user device 112 displays the queue message. A user may enter the queue as previously described.

At step 682, user device 112 displays the graphics file of the coupon. At step 683, user device 112 presents the graphics file of the coupon to brick-and-mortar store device 111. At step 684, brick-and-mortar store device 111 acknowledges the graphics file of the coupon. At step 685, the system server logs an expiration of the coupon when the timer expires. At step 686, the system server generates a coupon expiration message. At step 687, system server transmits the coupon expiration message to user device 112. At step 688, user device 112 displays the coupon expiration message.

Referring to FIG. 6C an alternate embodiment of step 605 will be described. In step 689, user device 112 generates a table of automatic queue preferences. Automatic queue preferences can include automatic functions implemented by the system server when a set of predetermined conditions is met. In one preferred embodiment, a preset GPS perimeter can be defined by the user device as an automatic queue preference. In another preferred embodiment, a predefined search term for product queues can be set as an automatic queue preference. For example, predefined search terms can be types of items such as “headphones,” “batteries” or “car washing services.” In another embodiment, a predefined automatic queue preference can be a date or time range during which a particular product or service is desired. In another preferred embodiment, an automatic queue preference can be a system setting for the mobile application such as to control brightness, volume, display notification preferences or language of operation.

At step 690, the automatic queue preferences are transmitted to the system server. At step 691, the automatic queue preferences are stored. At 692, the system server implements the automatic queue preferences. With respect to automatic queue preference of GPS location, the system server, upon implementation, responds by automatically entering the user device in the product queue for each product within the GPS range set when the user device is within the preset GPS perimeter. With respect to the automatic queue preference of predefined search terms, the system server automatically places the user device in each product queue which meets the search term parameters. With respect to the automatic queue preference of date or time range, the system server places the user device in the queue corresponding to each specified time period.

At step 693, user device 112 implements local automatic queue preferences such as screen brightness, language preferences and volume settings.

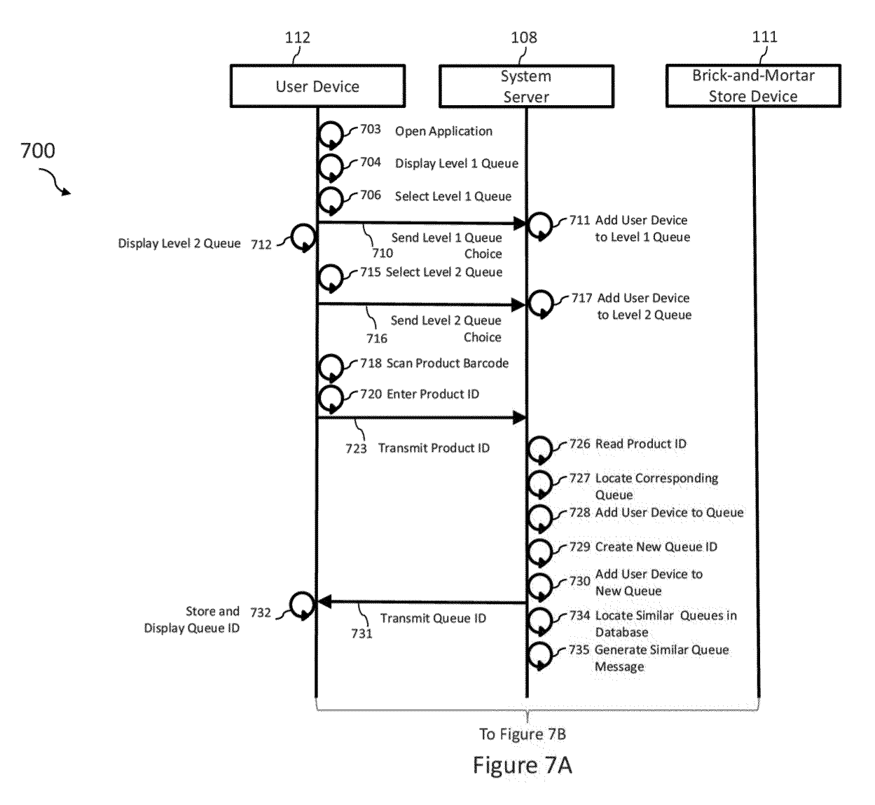

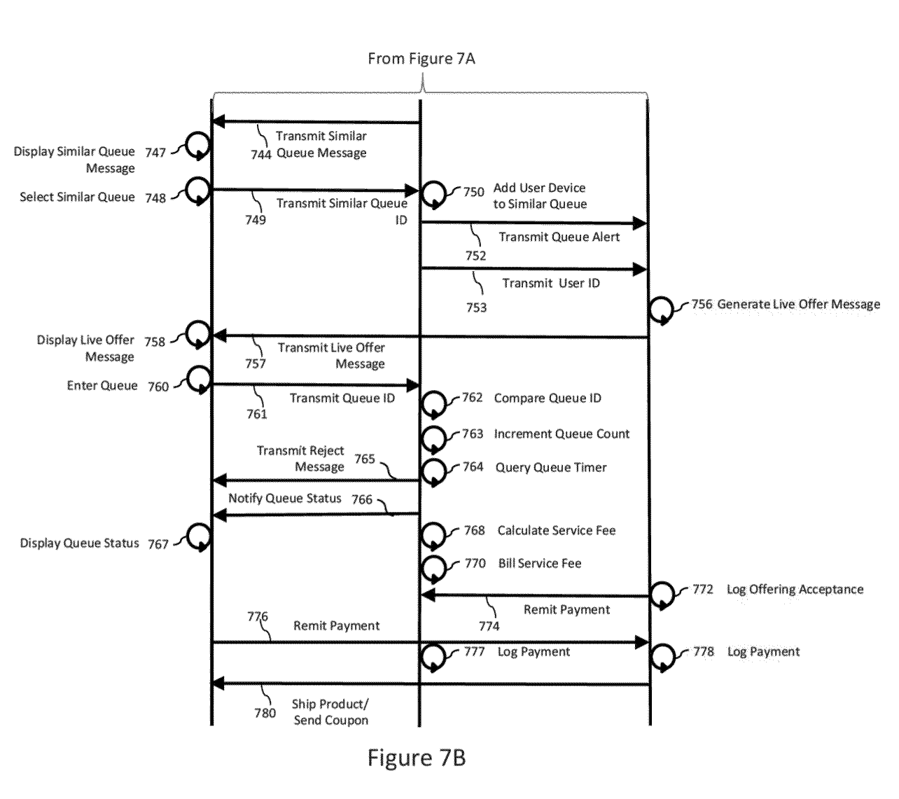

Referring then to FIG. 7A, an alternate preferred embodiment is described as method 700. At step 703, user device 112 opens application 113. At step 704, the user device displays “level one” queues. A level one queue includes categories of goods typically found in a brick-and-mortar store, such as electronics, home appliances and tools. At step 706, the user device selects a level one queue. At step 710, the user device sends the level one queue choice to system server 108. At step 711, system server 108 adds the user device to the level one queue and increments the queue count. At step 712, the user device displays available “level two” queues. A level two queue is a type of product found within each level one category, such as computers, televisions and stereos. At step 715, the user selects the level two queue on user device 112. At step 716, the level two queue choice is sent to the system server. At step 717, the system server adds the user device to the level two queue and increments the queue count. At step 718, user device 112 scans a physical product bar code on a product at a brick-and-mortar store. Alternatively, at step 720, the user enters a product identification number. At step 723, the product identification number is transmitted to the system server. At step 726, the system server reads the product identification number. At step 727, the system server locates any existing queue corresponding with the product identification number. If a corresponding queue is located, then at step 728, the user device is added to the queue and the queue count is incremented. At step 729, if no corresponding queue is located, then the system server creates a queue identification number. At step 730, the user device is added to a new queue and the new queue count is incremented. At step 731, the queue identification number is transmitted to the user device. At step 732, the user device stores the queue identification number, displays the queue identification number and the queue status. At step 734, the system server locates similar queues for similar level one queues and similar level two queues in the database. In a preferred embodiment “similar queues” are located by the system server by searching the database for pending queues that match general search terms for products, in the case of level one queues or by searching product descriptions, in the case of level two queues. At step 735, the system server generates a similar queue message.

Moving then to FIG. 7B, at step 744, the system server transmits a message identifying the similar queues available to the user device. At step 747 the user device displays a similar queue message. At step 748, the user selects a similar queue on the user device. At step 749, the similar queue identification number for each queue chosen is transmitted to the system server. At step 750, the system server adds the user device to each similar queue chosen and increments the similar queue count. At step 752, the system server sends a queue alert to brick-and-mortar store device 111. At step 753, the system server transmits the user identification number to the brick-and-mortar store device. At step 756, brick-and-mortar store device 111 generates a “live offer” message. A live offer message can be a message related to the queue or related to other products in the brick-and-mortar store which are in the proximity of the queued product, in the proximity of the products in the level two queue and/or in the proximity of the products in the level one queue. At step 757, the brick-and-mortar store transmits the live offer message to the user device. At step 758, the user device displays the live offer message.

At step 760, the user enters the queue on the user device. At step 761, user device 112 transmits a queue identification number to the system server. At step 762, the system server compares the queue identification number to the vendor program stored in the database. At step 763, the system server increments the queue count by the number of products requested for purchase. At step 764, the system server queries the queue timer. At step 765, if the queue timer has expired, the request to enter the queue is rejected and a message is sent to the user device. In another preferred embodiment, if the queue timer has expired a message is sent to the user device requesting that it enter another queue. In this embodiment, the queue size automatically resets to zero (0) when it reaches the critical mass number. In another preferred embodiment, if the queue timer has not yet been activated, then the queue timer is activated.

At step 766, the user device is notified as to the queue status. If the queue count has reached a predetermined number, the “critical mass” number, and if the queue timer has not expired, then user device 112 is notified of the acceptance of the offer. If the queue count has not reached the critical mass number by the time the queue timer has expired, then the user device is notified of an expired queue and asked to join another queue. At step 767, the user device displays the queue status message.

At step 768, system server 108 calculates a service fee. At step 770, the brick-and-mortar store device is billed the service fee. At step 772, the brick-and-mortar store device logs an offering acceptance. At step 774, the brick-and-mortar store device remits payment to the system server. At step 776, the user device automatically remits payment. At step 777, the system server logs the payment. At step 778, the brick-and-mortar store device logs the payment.

At step 780, the product is shipped to user. In an alternate embodiment, at step 780, a coupon is provided for a discount on the product or service. The coupon includes the hash code as previously described.

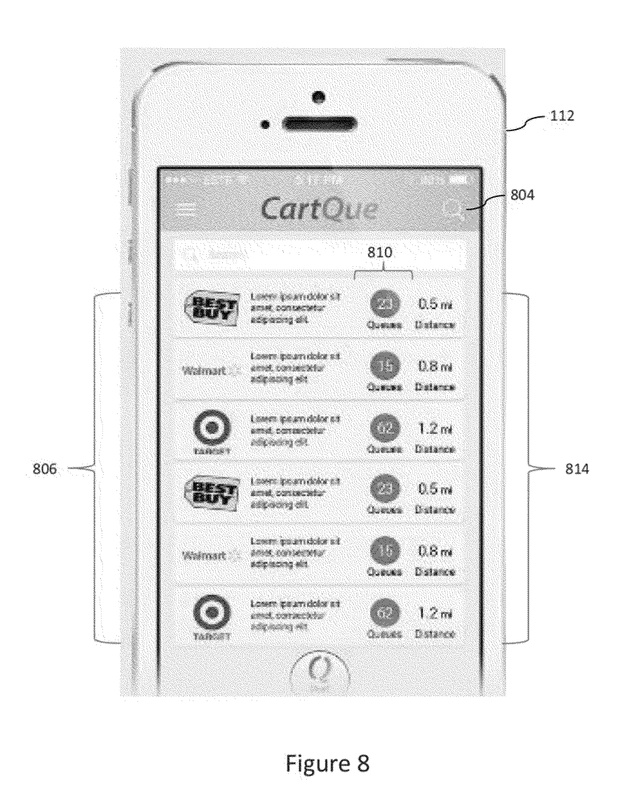

Referring then to FIG. 8, a display screen on a user device is shown. User device 112 displays application 804. Application 804 includes brick-and-mortar store identification column 806. Brick-and-mortar store identification column 806 shows the brick-and-mortar stores participating in active queues on the system. Queue numbers 810 are also displayed for each store on the application. The application also displays a distance 814 from the user device to the brick-and-mortar store.

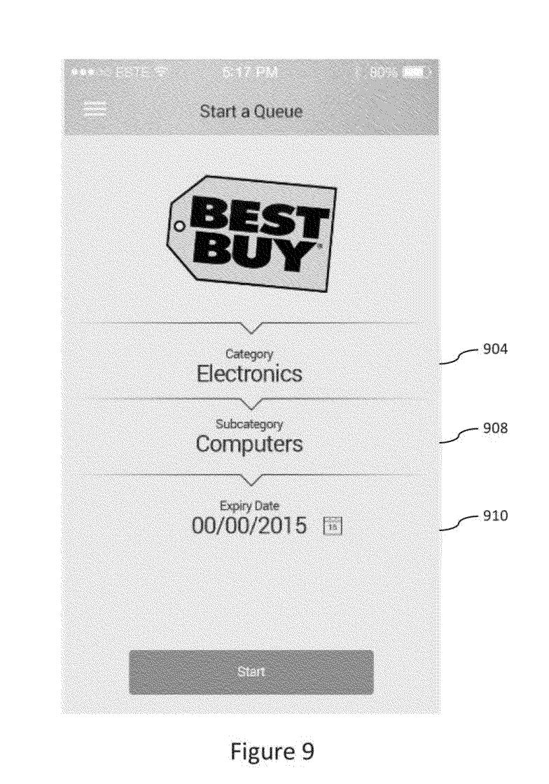

Referring to FIG. 9, an alternate embodiment of a display of an application of the system running on user device 112 is shown. In this display, category 904 displays a general type of products “electronics”. Subcategory 908 displays a specific type of products within the category displayed. The application also discloses expiration date tab 910 for the queues in the categories and subcategories.

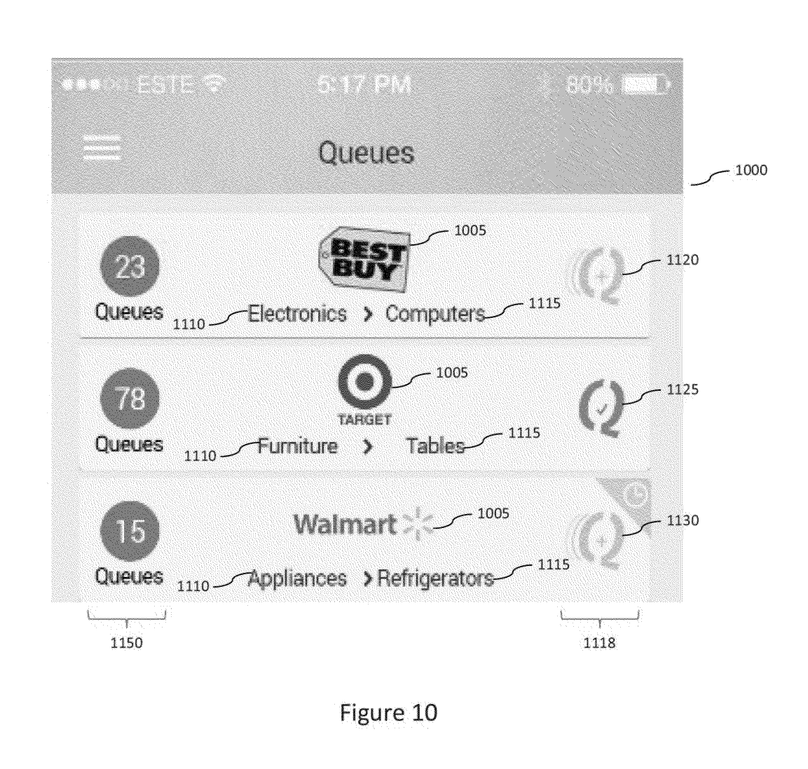

Referring then to FIG. 10, a preferred embodiment of a mobile phone display of a mobile application of the system is shown. In display 1000, brick-and-mortar store identification graphics 1005 are displayed in horizontal “choice” blocks. For each store, categories 1110 are shown. Similarly, for each store and each category, subcategory 1115 is shown. Indicator column 1118 is shown and in the indicator column, icon 1120 is shown, indicating that the queue is open to be entered. Icon 1125 is shown indicating a closed queue. Icon 1130 is shown with an open queue about to time out. Display 1000 also includes queue column 1150. The queue column includes an indicator of the number queues active in the indicated category/subcategory.

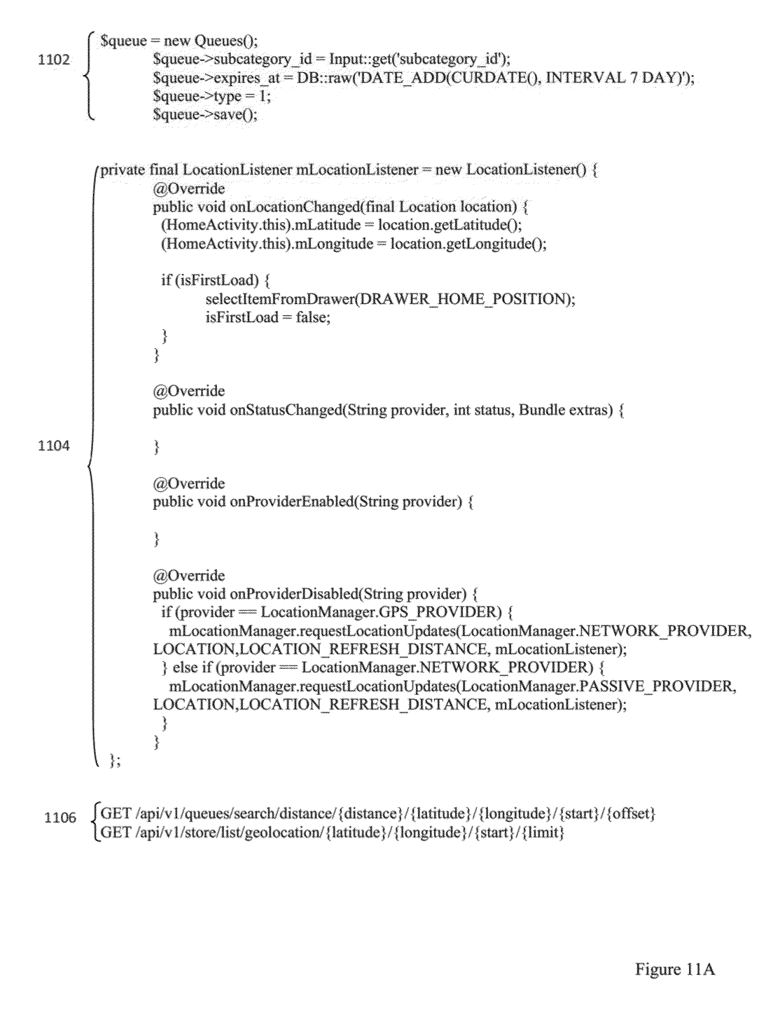

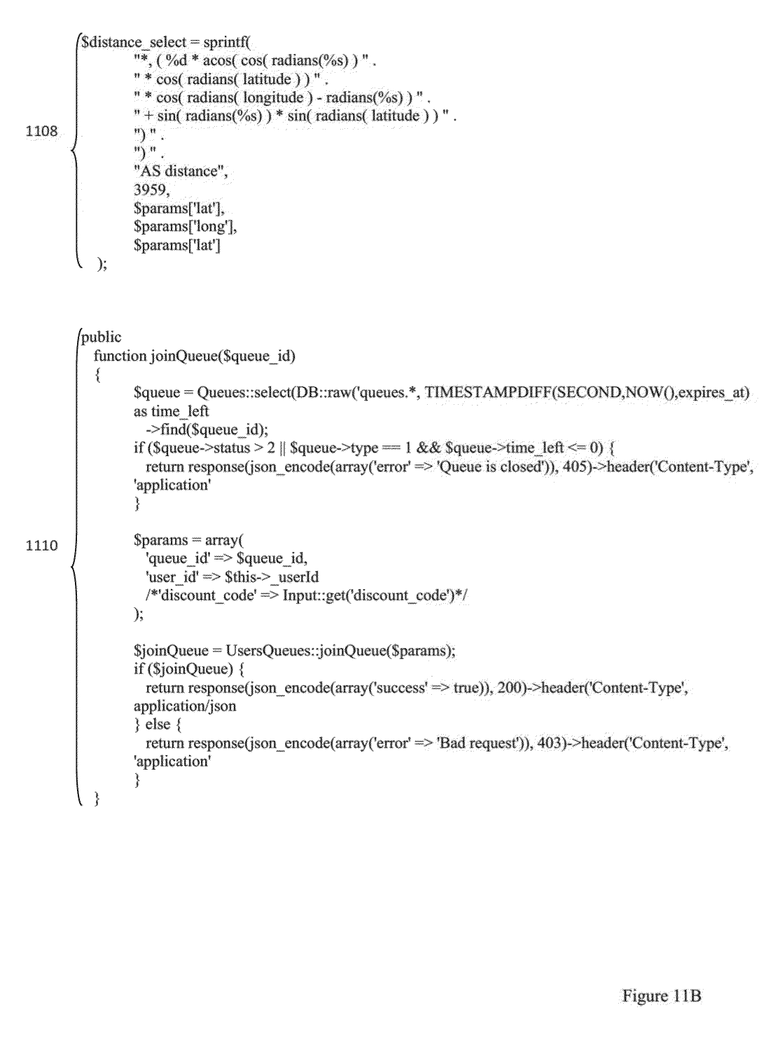

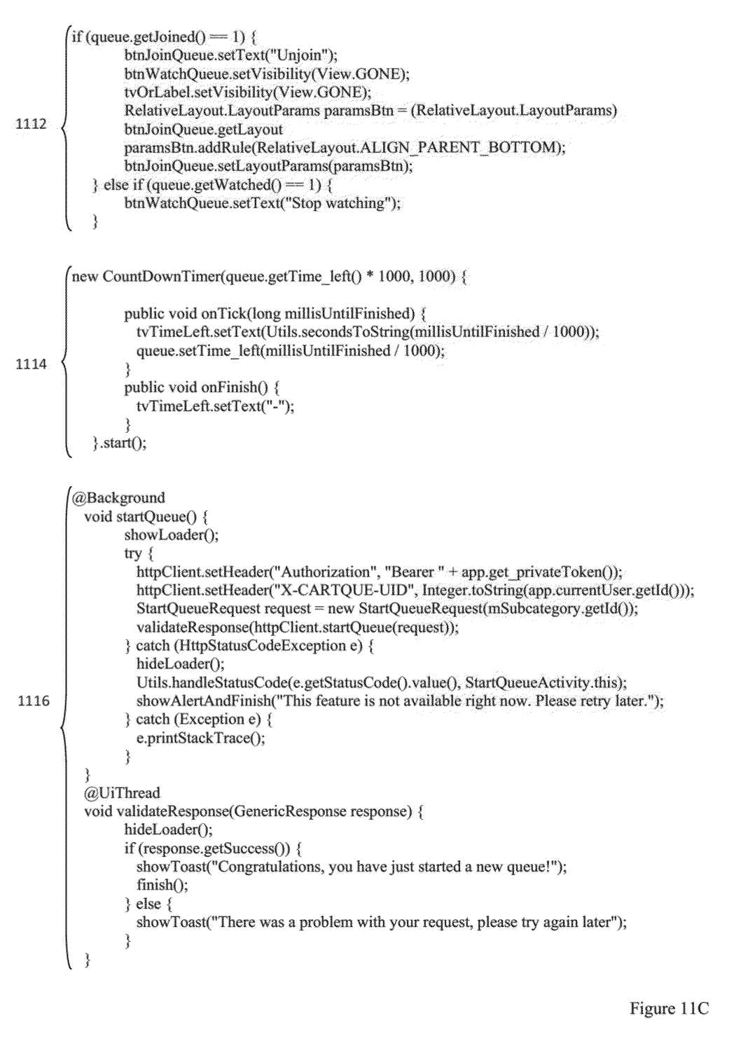

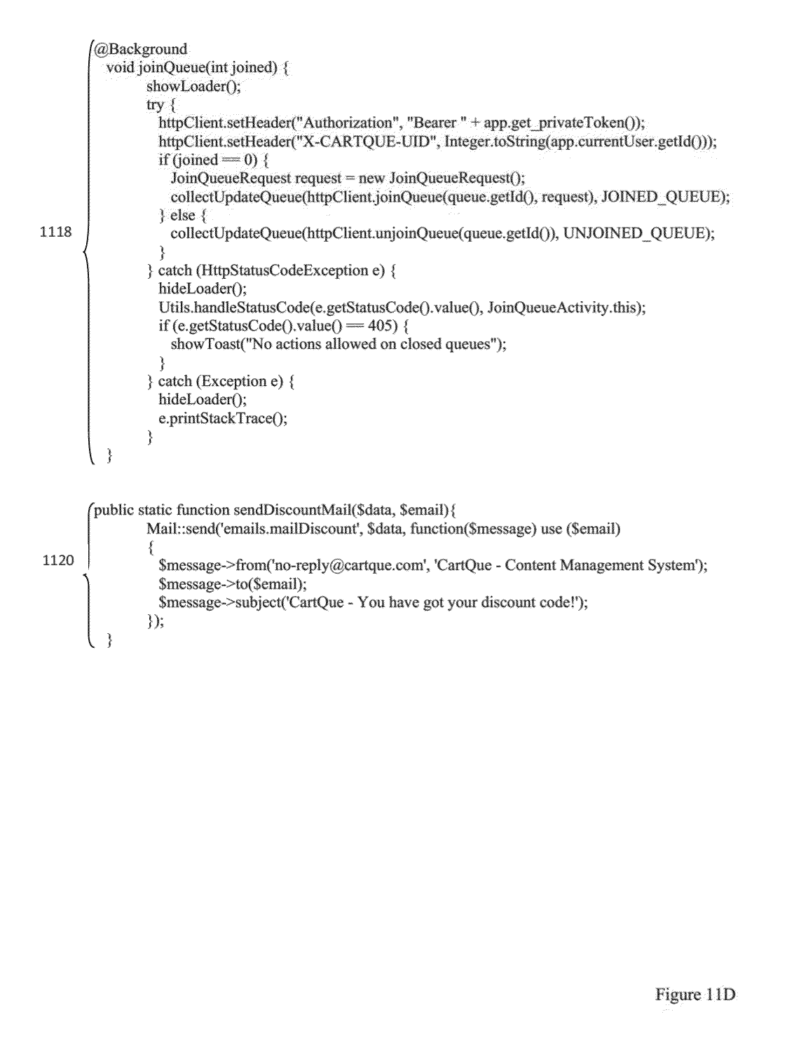

Referring to FIG. 11A, section 1102 shows an example of source code for generating a queue schedule from a brick-and-mortar store for a preferred embodiment. Section 1104 shows an example of the source code for transmitting a GPS range of a queue of a preferred embodiment. Section 1106 shows an example of the source code for transmitting the location of a user device of a preferred embodiment.

Referring to FIG. 11B, section 1108 shows an example of the source code for analyzing the position of a user device to determine if the user device is within the GPS range of the queue of a preferred embodiment. Section 1110 shows an example of the source code for when a user selects to enter a queue.

Referring to FIG. 11C, section 1112 shows an example of the source code for how the system aggregates a queue status and determines if the queue status has reached a pre-determined level of a preferred embodiment. Section 1114 shows an example of the source code for starting a queue timer of a preferred embodiment. Section 1116 shows an example of the source code for generating a queue start message for a new queue of a preferred embodiment.

Referring to FIG. 11D, section 1118 shows an example of the source code for adding a user to a “level one queue” and increments the queue count for that queue of a preferred embodiment. Section 1120 shows an example of the source code for providing a coupon to a user device of a preferred embodiment.

The sections of code correspond to the previously described steps according to the following table:

TABLE 1

| Code Section | Step |
|---|---|
| 1102 | 605 |
| 1104 | 614 |
| 1106 | 629 |
| 1108 | 633 |
| 1110 | 640 |
| 1112 | 660 |
| 1114 | 672 |
| 1116 | 676 |
| 1118 | 711 |
| 1120 | 780 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. An automated product purchase queuing system resident on a network comprising:
a server, having a memory and a database, connected to the network;
a user device connected to the network;
a user profile associated with the user device and stored in the database;
a set of terms for a product stored in the database; and,
the server configured to:
establish a queue in the memory;
recognize the user device;
add the user device to the queue and increment a queue count of the queue;
query a status of the queue;
communicate the queue status to the user device; and,
when the queue count meets the set of terms, send a notification to the user device.

2. The automated product purchase queuing system of claim 1:
the server further configured to:
receive a queue identification number of the queue from the user device; and,
add the user device to the queue based on the queue identification number; and,
the user device configured to:
display an acceptance;
wherein the notification indicates the acceptance of an offering when the queue count has reached a critical mass number of the queue in the set of terms before a queue timer of the queue expires.

3. The automated product purchase queuing system of claim 2:
wherein when the offering is an offering of the product, a payment is received from the user device by a vendor that made the offering; and,
wherein after the payment is received by the vendor, the product is shipped by the vender to a user of the user device.

4. The automated product purchase queuing system of claim 2:
wherein when the offering is a coupon, the coupon is sent from a vendor of the offering to the user device; and,
the user device further configured to display the coupon when the coupon is received.

5. The automated product purchase queuing system of claim 2:
wherein the notification indicates a rejection of the offering when the queue timer has expired before the queue count has reached the critical mass number; and,
the user device further configured to display the rejection.

6. The automated product purchase queuing system of claim 1:
the server further configured to:
transmit an offer to a vendor device to open negotiations between the server and the vendor device;
receive a counter offer from the vendor device responsive to the offer;
transmit the counter offer to the user device; and, receive an acceptance of the counter offer from the user device;
wherein the offer and the counter offer are according to predetermined schedules, price levels, and product inventory levels that are resident on the system server and the vendor device; and,
the user device further configured to display the counter offer.

7. The automated product purchase queuing system of claim 1:
the server further configured to:
receive a queue schedule that includes a calendar of when an offer for the product will be provided;
receive a global positioning system (GPS) range of where the offer will be provided;
receive a location of the user device from the user device;
transmit a queue schedule message to the user device when the user device is within the GPS range;
receive a selection of the queue from the user device based on the queue schedule message; and,
the user device further configured to display the queue schedule message.

8. A server of an automated product purchase queuing system that is resident on a network, the server comprising:
a memory, a database, and a connection to the network;
wherein a user device is connected to the network;
wherein a user profile is associated with the user device and is stored in the database;
wherein a set of terms for a product is stored in the database;
the server configured to:
establish a queue in the memory;
recognize the user device;
add the user device to the queue and increment a queue count of the queue;
query a status of the queue;
communicate the queue status to the user device; and,
when the queue count meets the set of terms, send a notification to the user device.

9. The server of claim 8:
the server further configured to:
receive a queue identification number of the queue from the user device; and,
add the user device to the queue based on the queue identification number;
wherein the notification indicates an acceptance of an offering when the queue count has reached a critical mass number of the queue in the set of terms before a queue timer of the queue expires; and,
wherein the acceptance is displayed by the user device.

10. The server of claim 9:
wherein when the offering is an offering of the product, a payment is received from the user device by a vendor that made the offering; and,
wherein after the payment is received by the vendor, the product is shipped by the vender to a user of the user device.

11. The server of claim 9:
wherein when the offering is a coupon, the coupon is sent from a vendor of the offering to the user device; and,
wherein when the coupon is received by the user device, the coupon is displayed on the user device.

12. The server of claim 9:
wherein the notification indicates a rejection of the offering when the queue timer has expired before the queue count has reached the critical mass number; and,
wherein the rejection is displayed by the user device.

13. The server of claim 8:
the server further configured to:
transmit an offer to a vendor device to open negotiations between the server and the vendor device;
receive a counter offer from the vendor device responsive to the offer;
transmit the counter offer to the user device; and,
receive an acceptance of the counter offer from the user device;
wherein the offer and the counter offer are according to predetermined schedules, price levels, and product inventory levels that are resident on the system server and the vendor device; and,
wherein the counter offer is displayed on the user device.

14. The server of claim 8:
the server further configured to:
receive a queue schedule that includes a calendar of when an offer for the product will be provided;
receive a global positioning system (GPS) range of where the offer will be provided;
receive a location of the user device from the user device;
transmit a queue schedule message to the user device when the user device is within the GPS range;
receive a selection of the queue from the user device based on the queue schedule message; and,
wherein the queue schedule message is displayed on the user device.

15. A method for an automated product purchase queuing system resident on a network that comprises: a server, having a memory and a database, connected to the network, a user device connected to the network, a set of terms for a product stored in the database, the method comprising:
establishing a queue in the memory;
recognizing the user device;
adding the user device to the queue and increment a queue count of the queue;
querying a status of the queue;
communicating the queue status to the user device; and,
when the queue count meets the set of terms, sending a notification to the user device.

16. The method of claim 15, further comprising:
receiving a queue identification number of the queue from the user device;
adding the user device to the queue based on the queue identification number; and,
displaying an acceptance;
wherein the notification indicates the acceptance of an offering when the queue count has reached a critical mass number of the queue in the set of terms before a queue timer of the queue expires.

17. The method of claim 16:
wherein when the offering is an offering of the product, a payment is received from the user device by a vendor that made the offering; and,
wherein after the payment is received by the vendor, the product is shipped by the vender to a user of the user device.

18. The method of claim 16, further comprising:
wherein when the offering is a coupon, the coupon is sent from a vendor of the offering to the user device; and,
displaying the coupon on the user device when the coupon is received.

19. The method of claim 16, further comprising:
wherein the notification indicates a rejection of the offering when the queue timer has expired before the queue count has reached the critical mass number; and,
displaying the rejection on the user device.

20. The method of claim 15, further comprising:
transmitting an offer to a vendor device to open negotiations between the server and the vendor device;
receiving a counter offer from the vendor device responsive to the offer;
transmitting the counter offer to the user device;
receiving an acceptance of the counter offer from the user device; and,
displaying the counter offer on the user device;
wherein the offer and the counter offer are according to predetermined schedules, price levels, and product inventory levels that are resident on the system server and the vendor device.
